(19) United States
(12) Patent Application Publication
(10) Pub. No.: US 2026/0194871 A1
(43) Pub. Date: Jul. 9, 2026

(54) SYSTEMS AND METHODS FOR FACILITATING AUTONOMOUS ACTOR ARCHITECTURES

(71) Applicants: Children's Hospital Medical Center, Cincinnati, OH (US); Georgetown University, Washington, DC (US)

(72) Inventors: Michael SEID, Cincinnati, OH (US); David HARTLEY, Cincinnati, OH (US); Ophir FRIEDER, Washington, DC (US)

(21) Appl. No.: 19/443,796

(22) Filed: Jan. 8, 2026

Related U.S. Application Data
(60) Provisional application No. 63/743,331, filed on Jan. 9, 2025.

(51) Int. Cl. G05B 13/04

(52) U.S. Cl. CPC G05B 13/04

(57) ABSTRACT

A system for evaluating and enhancing an autonomous actor network includes: a first computer-implemented current state assessment module, assessing a current autonomous actor network representation and providing a first output; a second computer-implemented simulation module, using the first output and simulating potential individual and ensemble interventions in the current autonomous actor network and providing a second output indicating effects of the simulations; a third computer-implemented ranking and selection module, using the second output and assembling a third output in the form of a set of the potential interventions ranked by feasibility and potential impact to increase collaboration in the autonomous actor network; a fourth computer-implemented intervention evaluation module, using the third output to test multiple of the potential interventions at one or more levels providing a fourth output; and a fifth computer-implemented update and correction module, using the second output and the fourth output to update and/or correct the current autonomous actor network representation.

### CROSS REFERENCE TO RELATED APPLICATIONS

The current application claims the benefit of U.S. Provisional Application Ser. No. 63/743,331, filed Jan. 9, 2025, the disclosure of which is incorporated herein by reference.

### BACKGROUND

The current disclosure pertains to systems and methods for manipulating sets of autonomous actors so that they may achieve a common goal. More specifically, the disclosure pertains to systems and methods for facilitating and improving collaboration platforms for autonomous actors, such as those operating in an Actor Oriented Architecture (AOA). An AOA is a design scheme for flexible, scalable systems, featuring autonomous “actors” (such as hardware and/or software components, people, bots, AI actors (or other like artificial intelligence entities) and the like) that communicate via asynchronous signals or messages, self-organize around shared “commons” (resources), and follow defined protocols, moving away from rigid hierarchies towards distributed, collaborative decision-making for better adaptability and resilience.

Elements of the AOA are 1) actors willing and able to self-organize in service of a common goal, 2) a commons where actors create and share resources, and 3) infrastructures, processes, and protocols that facilitate multi-actor collaboration. The AOA contrasts with traditional, hierarchical organizations/networks, which rely on a vertical management structure to assign tasks and needed resources to actors who then execute the work. AOAs empower actors throughout the organization/network to identify unsolved problems, assemble themselves into groups focused on solutions, and identify and access needed resources. Actor orientation refers to the characteristics of the organization enabling these circumstances to occur.

Complex systems consist of many interacting individuals and exhibit self-organizing. Collective behavior (“emergence”) is not necessarily due to a central controller and may be difficult to anticipate from individual behavior alone. Systems with these characteristics require a problem-solving approach that is resilient, adaptable, and collaborative. Collaboration—the sharing of information, resources, and responsibilities to jointly plan, implement, and evaluate activities to achieve shared goals—is even more critical in the face of acute stressors and in light of existing fragmented systems.

AOAs are examples by which to design, develop, and implement efficient, sustainable, explainable, scalable, and reliable such complex systems. AOA architectures can be used to sustain and operate a wide variety of networks. For example, AOA architectures can support the processing of a nuclear reactor, a distributed computer system, a pizza baking shop, and a learning health system.

In one example, an actor-oriented architecture for a nuclear reactor, individual components like control rods, fuel assemblies, and coolant pumps are modeled as independent, autonomous “actors” that communicate solely through asynchronous message passing. For instance, a “Temperature Sensor” actor might periodically send state updates to a “Control Rod” actor, which then independently decides whether to adjust its position based on pre-defined local safety protocols. This decoupling ensures that a failure or delay in one subsystem does not block the operation of others, providing the high level of fault tolerance and deterministic responsiveness required to maintain a stable fission chain reaction.

In one example, when applied to a distributed computer system, an AOA provides “location transparency,” allowing the system to scale seamlessly across different CPUs, data centers, or cloud nodes without changing the underlying code. Each actor encapsulates its own state and logic, eliminating the need for complex shared-memory locks that often throttle performance in multi-threaded environments. A supervisor actor can monitor the health of child actors; if a specific node or process crashes, the supervisor can immediately restart the failed actor in a fresh state or on a different server, ensuring the distributed application remains resilient and responsive to user requests even during hardware failures.

In one example, when applied to a pizza baking shop, the actor model functions much like a real-world assembly line where each “worker” (actor) is specialized for one task. An “Order Taker” actor receives a message (the order) and passes a request to a “Dough Prep” actor, who then signals the “Chef” actor once the base is ready. This message-driven workflow allows the shop to handle high volumes of concurrent orders by naturally distributing work: if the “Oven” actor is busy, incoming pizzas wait in its “mailbox” (queue) without blocking the actor preparing the next batch of dough. This structure makes it easy to add more actors, such as an extra “Delivery Driver” actor during a busy Friday night, without disrupting the existing shop operations.

Without loss of generality, for the remainder of the disclosure, embodiments of the disclosure may be described primarily using a learning health system example.

An example application may operate in a healthcare systems' collaborative Learning Health Systems, for example with respect to chronic illness care and public health preparedness. Ninety percent of the nation's annual healthcare expenditures are for chronic and mental health conditions. Yet the US healthcare system ranks at or near the bottom in health care compared to other high-income countries, including access to care, administrative efficiency, equity, and health outcomes. Public health preparedness, in the US response to COVID-19, was, with a few notable exceptions at the local and sub-state levels, sorely lacking. After decades of US planning for a 1918-like pandemic, COVID-19 illustrated the tragic impact and lasting damage that the lack of rapid collaboration and coordination can have on human and public health.

Collaborative Learning Health Systems, also known as Learning Health Networks (LHNs), improve health outcomes and public health preparedness. LHNs have demonstrated increased remission from 60% to 82% among children and youth with Crohn's disease and ulcerative colitis across 110 centers and 30,000 patients, a 32% decrease in serious safety events across 150 hospitals, a 40% reduction in mortality from hypoplastic left heart syndrome for 95% of all children with this condition in the U.S., a decrease in stroke rates by 50% in children with heart failure who require a cardiac assist device across 50 hospitals, and an 18% reduction in bed days (about 190 fewer days in the hospital/year) for children in 3 of the poorest neighborhoods of Cincinnati across 8,800 children.

The LHN approach was applied to rapidly develop and improve COVID-19 situational awareness across regional public health and health systems in the Greater Cincinnati region of southwest Ohio. Beginning in February 2020, this approach was used to bring into operation, in a matter of weeks, a situational awareness and continuous learning system that would normally take years to institute. The system engaged people and organizations critical to the response; identified common goals achievable through coordinated effort; organized groups rapidly to focus on specific problems; communicated effectively and rapidly; and shared critical data, information, and expertise seamlessly. It is still utilized, most recently regarding national IV fluid shortages following Hurricane Helene. System users reported that the effort fostered a foundation of trust and pursuing equity, created a cohesive community coalition with shared alignment and goals, and made real-time data accessible for learning. They also reflected on how effectively we worked together to create adaptable, resilient infrastructure to create systems for learning.

LHNs are a versatile organizational form in health care delivery. These ongoing communities of patients and families, clinicians, researchers, improvers and other interested parties use an actor-oriented architecture (AOA) to facilitate collaboration at scale. An organization with an actor-oriented architecture is characterized by the presence of actors (e.g., human patients, clinicians, organizations) willing and able to self-organize in service of a common goal, a commons where actors create and share resources, and infrastructures, processes, and protocols that facilitate multi-actor collaboration. LHNs use social and technological infrastructure and implement a set of processes over several phases of development to achieve an actor-orientation.

LHNs are sociotechnical systems that are designed and can be optimized to facilitate resilient, adaptive collaboration, independent of field and application. However, these are few and small, relative to the need.

Another example application may apply to computer implemented collaborative platforms (such as Slack™, Teams™, Asano™, Trello™ and the like) that are designed so that various autonomous actors (e.g., people) using the platform(s) may accomplish specific goals or solve business problems through document management, idea sharing and task management. For example, collaboration platforms such as Teams™ aim to enable users to perform their tasks more efficiently, but do not address the way users organize to collaborate; thus, providing a need to improve collaboration at scale. Many of these collaborative platforms are not designed according to any scientific theory of multi-actor collaboration. They require actors themselves to go out of their way to become aware of their environment and those in the environment and oftentimes sift through vast amounts of information that may or may not be relevant. They require users or actors to search and find connections of people who may be like themselves or working similar issues and then make cold calls to try to connect with them. These platforms are able to show actors possible connections with other actors, but typically without taking into account or explaining sufficiently why those possible connections could results in a successful collaboration with respect to a specific goal. These platforms are effective for allowing contacts with those in the actors' current networks, but are typically not helping actors find collaboration outside of the actors' current network, especially in situations where information security is a large concern or in situations where organizations are heavily siloed. These platforms tend to prevent the adoption of supervised but seamlessly incorporated algorithms to identify behavioral patterns. Thus, there is a need for tools making optimal use of theory, data and situational awareness to continuously and adaptively improve collaboration. There is a need that the tool is objective, IE quantifiable, enabling it to be done automatically (i.e., without human intervention or with minimal human intervention).

Another example application may apply to autonomous actor networks in the form of highly concurrent distributed software-based applications, virtual actor frameworks, distributed AI/ML workloads and the like handling simultaneous operations (e.g., in financial trading, IoT platforms, large-scale data processing and the like) and relying on asynchronous communication. Another example of autonomous actor networks may apply to open-source software actor-oriented architectures. In an example open-source AOA, the actors (local and/or remote) are independent, lightweight units that encapsulate state and behavior, and communicate via asynchronous messages. Such open-source platforms provide robust foundations for building complex, concurrent software by implementing the actor model's core principles of concurrency, isolation, and fault tolerance.

Such software/computer based autonomous actor networks, may exhibit one or more of three protocol conditions that may be a significant detriment to the overall operation. The first detrimental protocol is referred to as “deadlock.” In this state, essentially nothing is happening with the autonomous actor network-activity has stopped. For example, a first actor may be waiting for the second actor for a certain communication and the second actor may simultaneously be waiting on the first actor for a communication; resulting in the system to freeze. The second detrimental protocol, livelock, is a related protocol condition as deadlock, but with livelock activity is occurring but no meaningful progress is being made. For example, with livelock, the network is communicating, activities are occurring, but there is some condition or trigger required for meaningful progression that is simply not happening nor will happen unless the livelock condition is resolved. The third detrimental protocol, starvation, is a situation in which there is a severely unbalanced consumption of network resources where one or more sessions or nodes are being starved for the resources that are being consumed by other sessions or nodes.

### SUMMARY

The current disclosure provides a large-scale Generalized Resilient Adaptive Collaborative Environment (an exemplary, non-limiting, embodiment referred to herein as “GRACE”) designed to address various technical issues associated with autonomous actor networks such as AOAs (or other systems in which autonomous actors are required to collaborate to achieve one or more goals), computer implemented industrial manufacturing (which may require controlling high-speed devices), computer implemented collaborative platforms, LHNs, distributed software-based applications and the like.

Embodiments of the current disclosure provide a platform that systematically enhances large-scale collaboration in autonomous actor networks. It iteratively assesses and optimizes how autonomous actor networks are organized—their organizational characteristics—to make collaboration more robust and effective. GRACE is domain agnostic, capable of being applied to any complex problem and any set of autonomous actors bringing different experience and expertise to the table. GRACE can host multiple entities simultaneously, each of which utilizes the platform to solve problems through collaboration.

GRACE measures actor orientation continuously, applying tools to interpret these measurements and suggesting areas for improvement, and adjusting the system to achieve higher degrees of actor orientation and collaboration. GRACE employs a sophisticated simulation model to avoid “thrashing”, i.e., incorporating interventions that improve some measures while degrading other measures followed by new interventions that correct the situation, thereby entering a cycle of correct and repeat. GRACE aims to optimize collaboration but employs guardrails to avoid diminishing returns after user-defined “good enough” measures have been achieved.

GRACE uses signals to create information for action. Actor actions and behavior are logged and transformed into information about actor engagement and collaboration. Network specific data including text (e.g., meeting minutes, user chats, and working papers) geospatial (e.g., location), and images/photographs (e.g., actor activity or condition identification) are used to derive information about AOA indicators, for example autonomous actor network infrastructures like the commons, processes, and protocols. These signals inform an autonomous actor network computer simulation and other tools to derive the most impactful and feasible interventions, which are tested and scaled. A goal of GRACE is to optimize collaboration between autonomous actors, enabling the emergence of more rapid and effective solutions, whether the autonomous actor network is concerned with healthcare outcomes, or other issues (e.g., protecting the food supply, responding to natural disasters, forecasting when a wave of patients may arrive at emergency departments in a pandemic, etc.).

In an embodiment, the platform intervenes to ensure the network structure and the protocols governing the rules of engagement of interacting do not promote conditions of deadlock, livelock or starvation, and if said conditions occur, they are remedied. In an embodiment, the platform watches everything that goes on and records network actor behavior, such as who interacts with whom, the frequency and topics of interaction, how actors interact with resources, including but not limited to data and expertise. In an embodiment, the platform computes metrics associated with collaboration based on these observations. In an embodiment, the platform analyzes those data and metrics in real time (or near real time) according to scientific theories and models of collaboration. In an embodiment, the platform identifies multiple candidate interventions to optimize one or more determinants or drivers of collaboration. In an embodiment, the platform automatically executes candidate interventions; evaluates the success of these candidate interventions and logs the interactions with their success ratings to enable repetitive mistake avoidance. In an embodiment, the platform retains the successful interventions into a new platform configuration and then the process is repeated, as necessary or desired, to optimize the network over time.

In a first aspect, a system for evaluating and enhancing an autonomous actor network (such as comprising an actor-oriented architecture (AOA)) is provided. The system includes: a first computer-implemented current state assessment module, assessing a current autonomous actor network representation and providing a first output; a second computer-implemented simulation module, using the first output and simulating potential individual and ensemble interventions in the current autonomous actor network and providing a second output indicating effects of the simulations; a third computer-implemented ranking and selection module, using the second output and assembling a third output in the form of a set of the potential interventions ranked by feasibility and potential impact to increase collaboration in the autonomous actor network; a fourth computer-implemented intervention evaluation module, using the third output to test multiple of the potential interventions at one or more levels providing a fourth output; and a fifth computer-implemented update and correction module, using the second output and the fourth output to update and/or correct the current autonomous actor network representation.

In a second aspect, a method for evaluating and enhancing an autonomous actor network (which may comprise an actor-oriented architecture (AOA)) is provided. The method includes steps of: assessing, by a first computer-implemented current state assessment module, a current autonomous actor network representation and providing a first output; simulating, using the first output by a second computer-implemented simulation module, potential individual and ensemble interventions in the current autonomous actor network and providing a second output indicating effects of the simulations; assembling, using the second output by a third computer-implemented ranking and selection module, a third output in the form of a set of the potential interventions ranked by feasibility and potential impact to increase collaboration in the autonomous actor network; testing, using the third output by a fourth computer-implemented intervention evaluation module, multiple of the potential interventions at one or more levels to provide a fourth output; and updating and/or correcting the current autonomous actor network representation by a fifth computer-implemented update and correction module, using the second output and the fourth output.

In a more detailed embodiment of the first or second aspect, the first output includes an indicator matrix and a dashboard depicting individual metrics within each category of actor information and a summary of system metrics. Alternatively, or in addition, the first computer-implemented module ingests a corpus of text or other data concerning the current autonomous actor network and searches for actor-oriented indicators. Alternatively, or in addition, the first computer-implemented module logs data of user behavior in the current autonomous actor network to derive autonomous actor network structure and metrics.

In another detailed embodiment of the first or second aspect, the second output includes a contour plot denoting the intervention terrain for the autonomous actor network to navigate to increase collaboration. Alternatively, or in addition, the second computer implemented module includes an agent-based model (ABM) computer program in which populations of agents (e.g., patients and/or clinicians) with various attributes interact according to rules predetermined environments (i.e., parameters), and models future states of collaboration and actor orientation associated with the current autonomous actor network with a range of values across parameters, wherein certain influential parameters are varied systematically over a range of values.

In another detailed embodiment of the first or second aspect, the third computer implemented model: generates interventions as multiple levels, including agent level, agent-network level, structural level and/or nested level; identifies a set of types of interventions likely to improve actor-oriented collaboration; generates interventions from the cover set that are tailored to the nature of the developmental stage of the current autonomous actor network; and ranks the interventions by impact and feasibility. In a further detailed embodiment, feasibility is addressed by: a degree to which the intervention can be implemented by the platform alone; a degree to which there is existing infrastructures, processes, and/or protocols; and a relative strength of the organization across dimensions of actor-orientation. Alternatively, or in addition, impact is determined by relative movement in collaboration due to the intervention.

In another detailed embodiment of the first or second aspect, the fifth computer implemented model uses a machine learning model to develop and improve algorithms for pushing appropriate resources, connecting the most relevant users, and identifying and predicting which users are likely for increased engagement or collaboration.

Another detailed embodiment of the first or second aspect may further include a sixth computer-implemented assessment and learning module that analyzes the performance of first, second, third, fourth and fifth computer implemented modules to learn from, store and have the ability to re-introduce successful interventions from the set of potential interventions. In a more detailed embodiment, the sixth computer-implemented assessment and learning module resides outside of a recursive loop comprising the first, second, third, fourth and fifth computer implemented modules. Alternatively, or in addition, the sixth computer-implemented assessment and learning module employs a plurality of resources including supervised machine classification and large language models to learn from the set of potential interventions and to provide one or more of transparency, explainability and fairness to the system. Alternatively, or in addition, the sixth computer-implemented assessment and learning module analyzes a recursive loop comprising the first, second, third, fourth and fifth computer implemented modules to monitor for and correct imbalanced resource allocation among actors in the autonomous actor network. Alternatively, or in addition, the sixth computer-implemented assessment and learning module analyzes a recursive loop comprising the first, second, third, fourth and fifth computer implemented modules to monitor for and correct at least one of livelock, deadlock or starvation conditions in the autonomous actor network.

Another detailed embodiment of the first or second aspects may further include a computer-implemented match-maker functionality configured to recognize collaboration gaps between two or more actors in the autonomous actor network and to set initiate and facilitate interactions between the two or more actors. In a more detailed embodiment, the match-maker functionality is configured to facilitate interactions between the two or more actors by generating invitations to collaborate among the two or more actors, wherein the invitations include purpose-value propositions for collaboration. In a further detailed embodiment, the invitations further include initial scripts for communication between the two or more actors. Alternatively, or in addition, the invitations facilitate scheduling a call or meeting between the two or more actors.

Alternatively, or in addition, the match-maker functionality generates and utilizes: a knowledge network layer of elements including topics that actors in the autonomous actor network are concerned with; a social-knowledge network layer that models how the actors in the autonomous actor network interact with elements in the knowledge network layer; and social-network layer that maps which actors are connected in the autonomous actor network. In a further detailed embodiment, the match-maker functionality is configured to: identify clusters of related topics in the knowledge network layer that differ by one or more of linguistic expression, language, dialect, education level, or knowledge level; determine if distinct, non-overlapping sets of actors correspond to the clusters of related topics; and initiates and facilitates interactions between the non-overlapping sets of actors that correspond to the clusters of related topics. In a further detailed embodiment, the match-maker functionality is configured to generate invitations for collaboration between the non-overlapping sets of actors that correspond to the clusters of related topics, wherein the invitations account for different linguistic expression, language, dialect, education level, or knowledge level between the non-overlapping sets of actors that correspond to the clusters of related topics. Alternatively, or in addition, the social network layer analyzes search queries of actors in the autonomous actor network against elements in the knowledge network layer, where the social network layer may be further configured to determine whether actors' search queries are ineffective with respect to elements in the knowledge network layer due to linguistic expression, language, dialect, education level, or knowledge level; and the match-maker functionality is configured to generate invitations for collaboration between actors using ineffective search queries and other actors identified as having knowledge related to topics queried in the ineffective search queries.

In a third aspect, a computer implemented collaborative platform includes: a computer implemented collaborative platform configured so that autonomous actors using the platform may accomplish specific goals or solve business problems through document management, idea sharing and task management; and a computer-implemented match-maker functionality configured to recognize collaboration gaps between two or more autonomous actors utilizing the computer implemented collaborative platform and to initiate and facilitate interactions between the two or more actors; where the computer-implemented match-maker functionality includes, (a) a knowledge network layer of elements including topics that actors in the autonomous actor network are concerned with, (b) a social-knowledge network layer that models how the actors in the autonomous actor network interact with elements in the knowledge network layer, and (c) social-network layer that maps which actors are connected in the autonomous actor network. In a further detailed embodiment, the match-maker functionality is configured to facilitate interactions between the two or more actors by generating invitations to collaborate among the two or more actors, wherein the invitations include purpose-value propositions for collaboration. In a further detailed embodiment, the invitations further include initial scripts for communication between the two or more actors. In a further detailed embodiment, the invitations facilitate scheduling a call or meeting between the two or more actors.

Alternatively, or in addition, the match-maker functionality is configured to: (x) identify clusters of related topics in the knowledge network layer that differ by one or more of linguistic expression, language, dialect, education level, or knowledge level; (y) determine if distinct, non-overlapping sets of actors correspond to the clusters of related topics; and (z) initiate and facilitate interactions between the non-overlapping sets of actors that correspond to the clusters of related topics. In a further detailed embodiment, the match-maker functionality is configured to generate invitations for collaboration between the non-overlapping sets of actors that correspond to the clusters of related topics, wherein the invitations account for different linguistic expression, language, dialect, education level, or knowledge level between the non-overlapping sets of actors that correspond to the clusters of related topics. Alternatively, in addition, the social network layer analyzes search queries of actors in the autonomous actor network against elements in the knowledge network layer, where the social network layer may be further configured to determine whether actors' search queries are ineffective with respect to elements in the knowledge network layer due to linguistic expression, language, dialect, education level, or knowledge level; and the match-maker functionality is configured to generate invitations for collaboration between actors using ineffective search queries and other actors identified as having knowledge related to topics queried in the ineffective search queries. Alternatively, or in addition, at least part of the match-maker functionality resides in a secure processing environment (i.e., black-box) that utilizes protected information from at least one of the autonomous actors and does not release any of the protected information outside of the secure processing environment

In a fourth aspect, a method for enhancing an distributed processing system including a plurality of autonomous actors comprising one or more distributed software-based applications, virtual actor frameworks, or distributed artificial intelligence workloads is provided. The method includes steps of: assessing by one or more processors the current autonomous actor network comprising the plurality of autonomous actors and providing a first output; simulating by the one or more processors potential individual and ensemble interventions in the current autonomous actor network and providing a second output indicating effects of the simulations; assembling by the one or more processors a third output in the form of a set of the potential interventions ranked by feasibility and potential impact to improve operation of the autonomous actor network; testing by the one or more processors multiple of the potential interventions at one or more levels to provide a fourth output; and updating and/or correcting by the one or more processors the current autonomous actor network using the second output and the fourth output. In a more detailed embodiment, the method further includes analyzing by the one or more processors the performance of assessing, simulating, assembling, testing and updating and/or correcting steps to learn from, store and have the ability to re-introduce successful interventions from the set of potential interventions. Alternatively, or in addition, at least some of the potential interventions are provided to correct livelock, deadlock and/or starvation conditions in the autonomous actor network.

In a fifth aspect, a non-transitory memory (or memories) includes computer instructions configured to direct one or more processors to perform any of the methods of the first, second, third or fourth aspects.

In a sixth aspect, any of the first, second, third or fourth aspects may be implemented with, integrated within, or provided as an extension or add-on to any computer implemented collaboration platform or any computer implemented social networking platform.

### BRIEF DESCRIPTION OF THE DRAWINGS

FIG. 1 provides a block diagram representation of an exemplary embodiment of the GRACE platform according to various embodiments of the current disclosure;

FIG. 2 provides an exemplary flow diagram illustrating the five core software modules of the exemplary GRACE core and an additional Assessment Module according to various embodiments of the current disclosure;

FIG. 3 provides an example of a graphical user interface dashboard for an operator or administrator, which essentially displays the current state of the network as developed by Module 1.0 according to a specific embodiment of the current disclosure;

FIG. 4 provides an example of a graphical user interface dashboard for an operator or administrator, which can display the current state of the network at Module 2.0 according to a specific embodiment of the current disclosure;

FIG. 5 provides an example of a graphical user interface dashboard for an operator or administrator, which can display the current state of the network at Module 3.0 according to a specific embodiment of the current disclosure;

FIG. 6 provides an example graphical user interface for a user (i.e., actor) in a computer implemented collaboration platform in which a curbside consult intervention is recommended according to a specific embodiment of the current disclosure;

FIG. 7 provides an example of a similar dashboard in which the system is proactively suggesting to a user, other actors in the network who may help the user with a topic that the user is working on, and also provides a pre-drafted (and/or editable) message that the user can select to open up communication/collaboration according to a specific embodiment of the current disclosure;

FIG. 8 provides an example of a dashboard in which the system proactively recognizes that two actors are working on things and/or have knowledge that could be mutually beneficial to each other and then creates a microstructure to promote interaction between the two actors according to a specific embodiment of the current disclosure; and

FIG. 9 provides an example of a graphical user interface dashboard for an operator or administrator, which can display the current state of the network at Module 5.0 showing the operator what happened in the latest run through the GRACE core loop according to a specific embodiment of the current disclosure.

### DETAILED DESCRIPTION

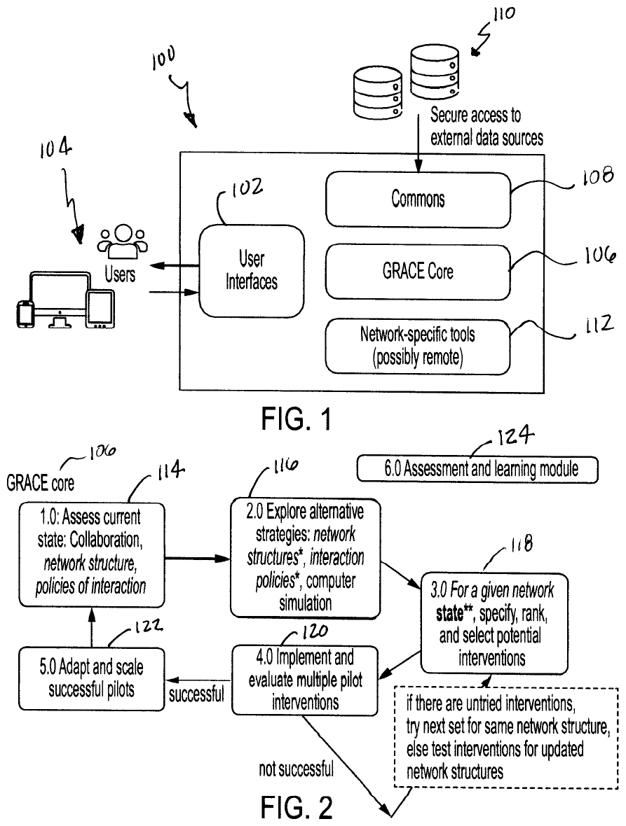

FIG. 1 provides a block diagram representation of an exemplary embodiment of the GRACE platform 100. “User Interfaces” 102 serve as the principle principal point of interaction between users 104 (including inter alia end users collaborating on one or more projects and administrators monitoring and managing the platform) and platform components including the GRACE core 106. An important aim of the user interface 102 is to allow effective operation of GRACE from the human end, while GRACE simultaneously feeds back information that aids the users' collaborative or administrative processes. There may be different visual appearance and tools available for collaborative versus administrative (or other) user types. “Commons” 108 is an area where actors create and share resources, and infrastructures, processes, and protocols that facilitate multi-actor collaboration. The commons 108 is an area where such products (e.g., products containing data and information in different forms) are stored and accessed (“shared”) with users. The commons 108 may also receive and share data 110 external to the platform 100. The “GRACE Core” 106 processing component(s) enables, facilitates, and optimizes high levels of collaboration continuously. It is embodied in a set of software modules that operate in a sequential, recursive process as disclosed herein. “Network-Specific Tools” 112 accesses tools such as statistical calculators, continuous quality improvement trackers, or other online tools that collaborators may use from other platforms and are necessary to access for collaboration on GRACE.

FIG. 2 provides an exemplary flow diagram illustrating the five core software modules of the GRACE core 106 and an additional Assessment Module 124. As depicted in FIG. 2, the GRACE core 106 enables a complex sociotechnical system to continuously, and potentially autonomously, enhance and maintain high levels of collaboration. Embodied in a set of software modules, GRACE carries out the following processes sequentially and recursively.

Module 1.0 114 is an observational module that assesses the current state of the autonomous actor network in terms of collaboration and actor orientation based on platform logs of actor behavior (e.g., interactions between actors, access of existing data and information, production of new data or information), policies of interaction and other things. It also assesses the current state of collaboration by classifying and scoring individual actors (e.g., engagement), community (how actors collaborate within a grouping), and system (e.g., ease of accessing information stores or “commons”, situational awareness produced and shared, signaling about needs and skills, emergent norms of interacting) behavior continuously. Further, actor activity is screened and evaluated for collaborative mistakes and blunders such as files shared in places inaccessible to collaborators and messages sent to unintended parties and flagged for correction. If the state of collaboration meets or exceeds user-defined “good enough” criteria, no further action is taken.

Using the output of Module 1.0, Module 2.0 116 explores various network improvement strategies in terms of altering network structure, and identifies pitfalls to be avoided, using a computer simulation. It applies a computational model to simulate how to transform from a current state of network structure—measured in Module 1.0 114—into future states of more effective collaboration based a range of theoretically and empirically derived interventions. In some embodiments, simulation scenarios are logged for potential future analysis and to avoid repetitive evaluation. Filtering of logged scenarios to retain only those scenarios that represent events of greater interest.

Module 3.0 118 identifies, in one embodiment, using the simulation results from Module 2.0 116, a cover set of interventions to improve collaboration. In an embodiment, Module 3.0 ranks and/or specifies the impact of the different alternative strategies and selects a ranked list of what might be done to improve collaboration. The cover set is a minimal set of intervention types sufficient to achieve improved actor orientation and thus improved collaboration. In some embodiments, multiple cover sets are possible. Based on the selected cover set, module 116 specifies, ranks, and selects specific potential interventions most likely to improve collaboration, using outputs from Modules 1.0 114 and/or 2.0 116.

Module 4.0 120 implements, automatically in some instances or with human intervention in other cases, multiple pilot tests of the Module 3.0 118 specified interventions for one or more small sets of actors collaborating on the platform. In an embodiment, Module 4.0 120 starts working down the list of interventions suggested by Module 3.0 118 in the form of small pilot interventions—e.g., performed on a smaller subset of the entire platform to evaluate whether or not these suggested interventions are likely to succeed. It will be appreciated that the pilots may be performed on larger subsets, the entire platform or custom “sandbox” type platforms specifically designed to conduct the pilot tests. In an embodiment, Module 4.0 120 tests suggested interventions from Module 3.0 118 one at a time. If the suggested intervention is not likely to succeed, Module 4.0 120 returns to Module 3.0 118 for the next suggested intervention.

Module 5.0 122 adapts and scales one or more successful intervention selected by Module 4.0 120 throughout the GRACE platform 100. The process then may repeat, beginning with Module 1.0 1114. It is expected that that over time, the system will converge on one or more optimal states. Success may be defined by many different criteria based on the application and where it is being deployed, such as whether the result meets real-time conditions, cost constraints, energy requirements, training time and the like.

The circuit 3.0→4.0→3.0 comprises a problem-solving trajectory that identifies an effective intervention to improve collaboration, whereas the circuit 1.0→2.0→3.0→4.0→5.0→1.0, forms an evolutionary approach in which fitter solutions emerge. Implementing these modules on a platform that includes standards-based security, modern ETL processes, and flexible user interfaces defines the GRACE platform from an engineering perspective (FIG. 1). The GRACE core modules are described in detail below.

Module 6.0 124 is an assessment and learning module that resides outside of the circuit 1.0→2.0→3.0→4.0→5.0→1.0 and analyzes the performance of the circuit 1.0→2.0→3.0→4.0→5.0→1.0 over time. Module 6.0 124 may be implemented to identify and learn from the interventions, interfaces and network states that achieved success in the circuit 1.0→2.0→3.0→4.0→5.0→1.0 to be able to recognize in the future similar network states and potential interventions that are more likely to work. Module 6.0 124 may operate as a computational cost-saving measure to recognize known situations (e.g., output from Module 1.0 114) and provide potential short-cuts to solutions (e.g., provided directly to Module 5.0 122).

Any of the processes performed by any of Modules 1.0 114, Module 2.0 116, Module 3.0 118, Module 4.0 120, Module 5.0 122, and/or Module 6.0 124 (or any combination thereof) may be performed in real-time (information is or data are is processed as without noticeable delays, e.g., in milliseconds) or near real-time (information is or data are processed with slight delays, e.g., in seconds or under a minute). Further, operation of any of Modules 1.0 114, Module 2.0 116, Module 3.0 118, Module 4.0 120, Module 5.0 122, and/or Module 6.0 124 (or any combination thereof) may involve or require spawning multiple tasks, in real-time, as needed, for their coordination at scale.

Referring back to Module 1.0 114—Since autonomous actor networks may use an actor-oriented organizational architecture to facilitate collaboration, which consists of discrete factors that can be operationalized, instrumented, and modified; Module 1.0 114 assesses current states of collaboration and actor orientation within the autonomous actor network. At a high level, Module 1.0 114 ingests data from multiple sources to assess LHNs with respect to collaboration and actor orientation.

In a specific embodiment, Module 1.0 114 applies an ontology of user behavior and productivity to compute a score based on indicators of actor-orientation indicators. In an embodiment, these indicators are identified from: an automated crawler ingesting a corpus of text or other data from the organization (e.g., commons material, emails, messaging text, etc., housed by one or more IT platforms) and searches for the indicators—for example, keyword searches for terms associated with indicators of each type. NLP approaches, like sentiment analysis and LDA topic modeling and/or ultimately machine learning may also be applicable to identify indicators; logging data of user behavior on the platform (e.g., signing in, searching, viewing, downloading, messaging, editing, uploading) aggregated to derive network structure and metrics; and other artifacts such as dashboards, meeting minutes, user-produced resources, etc. In an embodiment, Module 1.0 114 also maps the social network structure and records interaction policies.

In a specific embodiment, Module 1.0 114 produces an indicator matrix and dashboards depicting individual metrics within each category of actor orientation, as well as summary and system metrics. These metrics may include: (1) collaboration metrics, such as (a) network node connectivity—the number, distribution, and strength of connections, or edges, among user-user and user-resource nodes; (b) node conductivity—the type and value of resources exchanged along these edges; (c) commons metrics—the amount and type of resources available to the network; and/or (d) problem-solving latency—the time elapsed between user-posed questions and the first answer; (2) actor-oriented architecture metrics, such as: (a) shared purpose—actors with the will and ability to self-organize; the number and roles of people and organizations; and engagement level of agents—aware, participating, contributing, owning/making; (b) shared resources—a commons where actors create and share resources including the amount and type of resources available, their ease of use, and their findability; and/or (c) shared processes—infrastructures, protocols, and processes that facilitate multi-actor collaboration, including the tools available for connecting, convening, creating shared situational awareness; the robustness of the technical architecture; the degree to which processes—the way work is done—are known and used to facilitate multi-actor collaboration; and the degree to which protocols—codes of conduct—are present, shared, used, enforced. Utilizing these and related metrics, an embodiment develops a Common Operating Picture (COP) of collaboration for users to monitor the trajectory of collaboration. The COP will form an important evaluation role as well as provide situational awareness on rate of collaboration improvement; and/or (3) social network structure metrics.

In an embodiment, the indicator matrix is a matrix of columns corresponding to elements of the actor-oriented architecture and rows corresponding to indicators of AOA activities in each category. This module may utilize the Actor Oriented Assessment tool disclosed in related U.S. application Ser. No. 18/673,812, the disclosure of which is incorporated herein by reference. As such an example of the indicator matrix may be as shown in FIG. 2 in the '812 application.

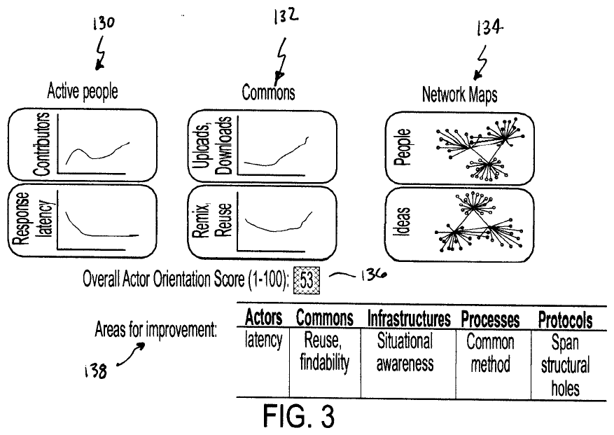

FIG. 3 provides an example of a graphical user interface dashboard for an operator or administrator, which essentially displays the current state of the network as developed by Module 1.0 114 for example. The state of the network may be represented by an indication of the active actors in the network 130 in terms of the number of actors and how quickly the actors respond to each other (response latency). The state of the network may also be represented by an indication of the commons 132 in terms of the number of uploads/downloads and whether actors are remixing or reusing items in the Commons. Network maps 134 may show ways that actors and/or ideas are connected in the network. An overall score 136 may be provided (in this case “53”-improvement needed). Finally, the dashboard may suggest areas for improvement 138 in the actors, commons infrastructures, processes and/or protocols.

Referring again to FIG. 2, because there is little or no systematic, reproducible assessment of the potential impact of many of the potential improvement interventions, Module 2.0 116 uses output from Module 1.0 114 as the current state to (1) suggest revisions to the network structure and policies of interaction to prevent livelock, deadlock, and starvation and (2) simulate the effect of potential individual and ensemble interventions on collaboration. In an embodiment, a “matchmaker” structure (described below) is included as part of suggesting revisions to the network structure and policies.

In a specific embodiment, Module 2.0 116 utilizes an agent-based model (ABM)—a computer program in which populations of agents (e.g., ‘patients’, ‘clinicians’) with various attributes interact according to rules and in environments specified by the modeler (termed ‘parameters’). The exemplary ABM models future states of collaboration and actor orientation associated with the current state (from Module 1 114), and with a wide range of values across parameters. Influential parameters (known via sensitivity analysis) are varied systematically over a range of values.

Agent-based models (ABMs) are computer programs in which populations of agents with various attributes interact according to rules and in environments specified by the modeler. Because ABMs model system-level effects of agent (e.g., autonomous actor) interactions, they are well-suited as a modeling tool for autonomous actor networks. A specific embodiment of an ABM as applied to a LHN is described in depth in U.S. Provisional Application Ser. No. 63/743,331 (and is an evolved and refined model as taught in related U.S. application Ser. No. 17/291,401 the disclosure of which is incorporated herein by reference) and in Michael Seid et al., “An Agent-Based Model to Advance the Science of Collaborative Learning Health Systems,” PLOS One 20(9): e0332054 (Sep. 9, 2025), the disclosure of which is incorporated herein by reference.

In an example implementation in which the autonomous actor network comprises an LHN, the ABM may include a set of patient and clinician agents and allows modelers to vary how the agents interact under different conditions. For three model outcomes of interest in a LHN-health status, praxis (knowledge available for making treatment decisions) and the amount of knowledge in the commons—the ABM may identify the most influential parameters for each and may show how varying these parameters result in different levels of the outcomes of interest. Sensitivity analysis is useful for understanding which elements, or combinations of elements of a model have the greatest impact on results, as well as how various elements interact. This is essential for model interpretability: If all or most model elements have similar impact on the outcomes of interest, little insight is gained for simplifying the model. For example, in many parameters in the LHN ABM, an embodiment identified the two that were most highly impactful to each of the three outcomes of interest in the model. For health status and praxis, there were two parameters that were clearly more impactful. For knowledge, there were two, and a close third. Notably, the highly impactful parameters had substantially higher partial rank correlations coefficients (PRCCs), suggesting parsimony. Thus, the ABM identifies a small number of parameters that might make large differences in outcomes.

The Module 2.0 116 may also utilize network analysis algorithms to prevent starvation (e.g., priority aging), livelock (e.g., terminal strongly connected component analysis) and deadlock (e.g., global state detection).

Various embodiments of Module 2.0 116, including the ABM, may be implemented by an agentic AI system. In an agentic AI implementation, each AI agent is modeled as an independent actor, a self-contained computational unit that encapsulates its own private state, including memories, context, and specific goals.

Communication between these agentic actors occurs exclusively through asynchronous message passing. Each actor maintains its own “mailbox” to queue incoming tasks, prompts, or data updates, processing them sequentially one at a time. This model is particularly effective for AI workloads because it allows agents to yield resources gracefully while waiting for long-running processes, such as Large Language Model (LLM) completions or external API calls. When an agent completes a reasoning cycle, it can spawn new child actors to delegate sub-tasks or send messages to peer agents to coordinate complex, multi-step workflows across a distributed system.

The architecture is governed by a supervision hierarchy that provides inherent fault tolerance. Parent actors monitor the health of their children; if an agent crashes due to a malformed prompt or a tool failure, its supervisor can automatically restart it, resume from a known checkpoint, or escalate the issue without bringing down the entire application.

The Module 2.0 116 generates outputs specifying the implications of changes to a subset of parameters. Contour plot outputs, for example, may denote the intervention ‘terrain’ that the autonomous actor network must navigate to increase collaboration. See FIG. A3 in U.S. Provisional Application Ser. No. 63/743,331 as examples of three different contour plots. Module 2.0 116 may also generate (1) outputs specifying the implications of changes to a subset of parameters and (2) potential network interaction policy revisions to avoid livelock, deadlock and starvation states.

Embodiments of Module 2.0 116 may include a matchmaker function. In very large autonomous actor networks, a problem arises in which one autonomous actor does not know if there are other autonomous actors who have expertise or solutions that are relevant for the problems the first autonomous actor is trying to solve. The exemplary matchmaker function will identify information need-have dyads (one-to-one, one-to-many, and/or many-to-many, mappings) and initiates and facilitates interactions between autonomous actors. For example, interaction facilitation may be provided by generating invitations to two or more actors to interact with purpose-value propositions to each party, scripts for interaction, and/or timing. Such interaction facilitation may make it easier for actors to both understand the value of responding to the invitation (why do I care about contacting this person?) and how to pursue the lead (if I reach out, what should I say?). This functionality may also take into account what language to use in the invitation, what dialect to use, automatic translation from one to another and curation level of what the actor(s) can understand and react to (and as a result may require real-time, or real-time, translation between multiple languages and/or dialects). This functionality may also take into account levels of knowledge about a particular subject and couch the communications at the same levels of knowledge of the recipient.

In a specific embodiment, an exemplary matchmaker procedure constructs and makes use of three layers of connections/interactions in the autonomous actor network. (1) A top knowledge network layer, which may be developed by applying topic modeling to information produced by actors in the network and constructing (e.g., through similarity metrics or ontology construction/tagging) how topics relate to one another. In this way, the embodiment may construct a layer populated by the topics the network is working on or has expertise in. This is the knowledge landscape of the network as manifest, for example, in information commons, messages, emails chats, data repositories and the like. (2) A middle social-knowledge network layer, which may be a model of how actors produce or interact (e.g., view, download, seek/look for) with elements of the knowledge layer. This could be, for example, the actors that write papers or reports, the actors who download or read reports, what information different actors search for, etc. This is the measurement of what actors do what with information in the network. (3) Lower social network layer, which may be the mapping of which actors are connected with which actors. While the exemplary embodiment, may provide a hierarchical layered structure as described above, it is also within the scope of the disclosure that the layers are not necessarily hierarchical (e.g., may use set-to-set dependencies and/or multi-value dependencies).

The matchmaker functionality constructs each of these three layers and analyzed projections of the different layers onto one another. In one instance, the knowledge layer identifies clusters of related knowledge that may differ by linguistic expression. If these clusters correspond, as identified in the social-knowledge layer, to distinct, non-overlapping sets of actors, then the matchmaker functionality selects actors from each distinct cluster for connection. Connecting might be direct or via in-common connections, as identified by the social network layer.

With respect to clusters and clustering, some embodiments may utilize Hierarchical Agglomerative Clustering (HAC), a method used to group similar data points into clusters based on their distance or similarity and to create a hierarchy or hierarchies of clusters. HAC is a “bottom-up” method that starts with each data point as its own cluster, then iteratively merges the two closest clusters based on a distance/similarity measure (e.g., Euclidean) and a linkage criterion or a combination thereof (e.g., single, complete, average) until the points form large cluster(s).

In other embodiments, actors searching for information but are not finding it or interacting with what is returned, possibly because they are not using appropriate search terms, are identified in the social knowledge layer. The terms they are using are linked to, via stored ontologies, clusters in the knowledge layer. Actors connected with those clusters of information are identified in the social-knowledge layer, thereby identifying an information have-need dyad. Those actors are then connected and instructions are supplied, based on the ontology linking vocabulary, to help them understand one another's expertise and needs.

In other embodiments, in the case of purposefully highly siloed organizations (e.g., where data/information secrecy or security is enforced within the organization), the matchmaker function may operate using black box technology such as disclosed in U.S. Pat. No. 11,681,965, “Specialized Computing Environment for Co-Analysis of Proprietary Data,” the disclosure of which is incorporated herein by reference. With the black box environment, no secret, proprietary or protected information is retrievable outside of this black box- and if an actor tries to get into the black box, the information goes away. With the matchmaker functionality operating within this black box, the matchmaker will have the necessary information within the black box to match the actors; and then can prepare the applicable invitations for collaboration without sharing any of the secret, proprietary or protected data. Evolving from the black box, for example, such invitations may end up being vague in the sense that the invitations explain that actor A may have an interest in actor B's knowledge about technology Y with explaining why actor A is interested in technology Y or why B has knowledge about technology Y due to information protections.

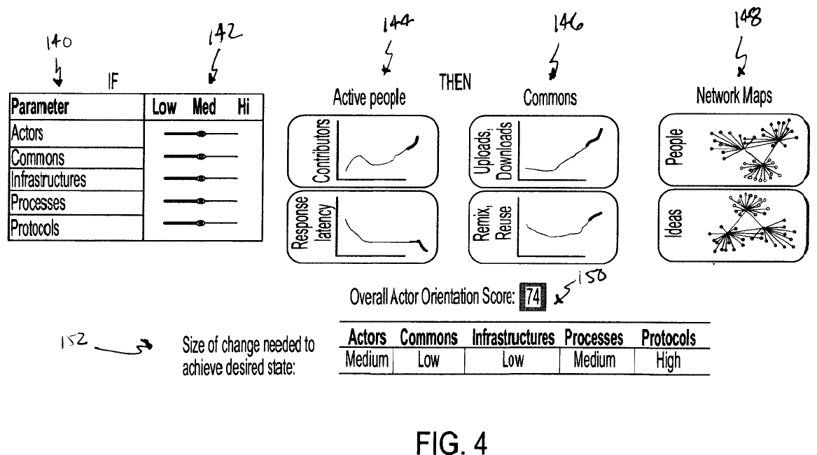

FIG. 4 provides an example of a graphical user interface dashboard for an operator or administrator, which can display the current state of the network at Module 2.0 116 for example, and allows the operator to vary different parameters 140 (e.g., using sliders 142) to see the predicted effect on the operation of the network as shown by predicted effect on active actors 144, commons 146 and network maps 148 resulting in a predicted score 150. In the example shown in FIG. 4, a predicted overall score of 74 (improved AOA score) and also shows the size of change needed to achieve this desired state in 152.

Referring back to FIG. 2, because the ABM of Module 2.0 116 may identify many possible interventions, the Module 3.0 118 uses what was learned by the ABM in Module 2.0 116 (and/or the matchmaker function) to specify, rank, and select proposed interventions. Specifically, Module 3.0 118 uses output from Module 2.0 116 to assemble a set of potential interventions, ranked by feasibility and potential impact, to increase actor-orientation and collaboration. For a given autonomous actor network structure (i.e., network state and how the network is changing time or iterations in the GRACE core 106 loop), the module generates interventions at multiple levels, generates interventions tailored to the nature of and developmental stage of the network and ranks interventions by impact and feasibility. The rankings may also prioritize interactions that avoid livelock, deadlock, and/or starvation.

The levels of interventions that may be generated by Module 3.0 118 (and/or by the match-maker functionality) may include: (1) Agent-level intervention that provisions an individual agent with resources (information, knowledge, knowhow)—examples include algorithms that predict knowledge gaps and push that knowledge to an agent, or identify shared problems and proactively connects an agent to another; (2) Agent-network level intervention that provisions the agent network with connections—examples might include attracting agents to a new problem, based on their existing interests or capabilities, or identifying boundary spanners and brokering connection between different communities; and/or (3) Structural level interventions that provision an entire community with infrastructure, protocols, or processes that facilitate collaboration—examples include but are not limited to shared situational awareness, protocols for identifying lanes of accountability, processes that make it easier to capture and share tacit knowledge. Interventions can also be nested—an agent level intervention might occur within an agent-network level intervention. For example, specific information might be pushed to an agent within the context of attracting agents to a new problem.

The Module 3.0 118 may then identify a cover set of types of interventions necessary to improve actor-orientation and collaboration. Next, from the cover set, the module generates interventions tailored to the nature of and developmental stage of the autonomous actor network. For example, rapid response to a public health emergency might require interventions to stand up a robust response quickly: achieve shared situational awareness, grow trust, promulgate protocols and processes, close structural holes (e.g., connect people or organizations so as to improve the flow of information or resources). Ongoing communities might require interventions to deepen the level of collaboration, draw more agents to the collaboration, or increase the conductivity of the agent-network. Newer networks might require interventions that advance social connectivity and trust; long-standing networks might require interventions that push resources or bridge structural holes.

Finally, the Module 3.0 118 ranks interventions by impact and feasibility. Impact may be determined by relative improvement in collaboration from ABM simulation, and feasibility may be assessed by the degree to which, e.g., the intervention can be implemented by the platform alone (versus by the community), the degree to which there is existing infrastructures, processes, and protocols (e.g., a common operating picture, protocols for signaling needs and abilities, standard procedures, lanes of accountability (i.e., what is OK to do without asking permission), and the relative strength of the organization across dimensions of actor-orientation.

Regarding multi-level intervention identification, an exemplary implementation includes constructing a look-up table approach for the theory-based rationale with explicit criteria for ranking and selecting ABM-generated interventions. The table will grow over time as more actors utilize GRACE 106. Initially, these may be manually and/or automatically generated (for example, in a manual implementation, the ABM identifies characteristics of needed interventions, but humans may be initially needed to generate interventions with the needed characteristics). The proven interventions may become part of a library of workable interventions, which can then be drawn upon in the future. When the ABM identifies a specified set of intervention characteristics, GRACE 106 may search the library for possible intervention matches—if there are matches, then those interventions will be used. If there are not, GRACE 106 may generate and/or propose interventions to be piloted and evaluated (or may prompt administrators to specify possible interventions to be piloted and evaluated). Ultimately, when the library grows sufficiently in size, AI may be implemented to predict appropriate interventions based on ABM output, past performance of interventions, and facets of the user population. Ranking will be a function of model-forecast payoff and feasibility of implementation. See, for example, the discussion of Module 6.0 124, below.

In an embodiment, Module 3.0 118 generates a portfolio of specified interventions, ranked according to impact and feasibility. A portfolio of interventions may include, in one embodiment, a matrix with columns for degrees of freedom of the ABM (e.g., the x- and y-axes of the contour plots generated from the model), model outcomes (e.g., the colors of the contour plots), and feasibility (initially, assessed by manually but later, learned from history). Each row of the matrix may define one intervention, e.g., increase frequency of sharing by prompting users to search the commons; increase the usage of data by improving search efficiency in the commons' search engine; improve influence by connecting people with expertise to people who need expertise by employing a matching approach; etc. Once this matrix is constructed, it can be sorted according to maximum payoff and feasibility, thereby achieving the necessary ranking.

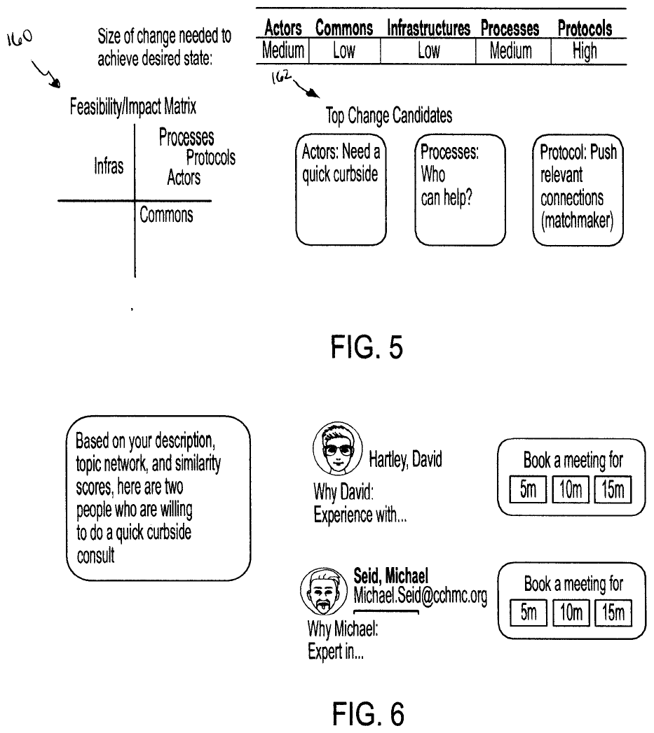

FIG. 5 provides an example of a graphical user interface dashboard for an operator or administrator, which can display the current state of the network at Module 3.0 118. For example, the dashboard may provide a feasibility/impact matrix 160 where the upper right quadrant shows the interventions that are most likely to be both feasible and impactful. Intervention candidates 162 may also be provided. For example, for Actors, a quick curbside consult (a quick conversation between actors who share experience with certain topics, “are we thinking the same way about this . . . ?”) may be recommended.

FIG. 6 provides an example graphical user interface for a user (i.e., actor) in a computer implemented collaboration platform in which a curbside consult intervention is recommended. In this example, the system is being proactive and determining that there is/are sufficient commonalities between two actors (who may not otherwise know about each other) to influence a short introduction. As shown in this example interface, a user is provided with candidates for short consults based on the user's description, topic network and similarity scores. For each candidate, the interface explains why the introduction may be beneficial and provide a link to calendar a quick meeting.

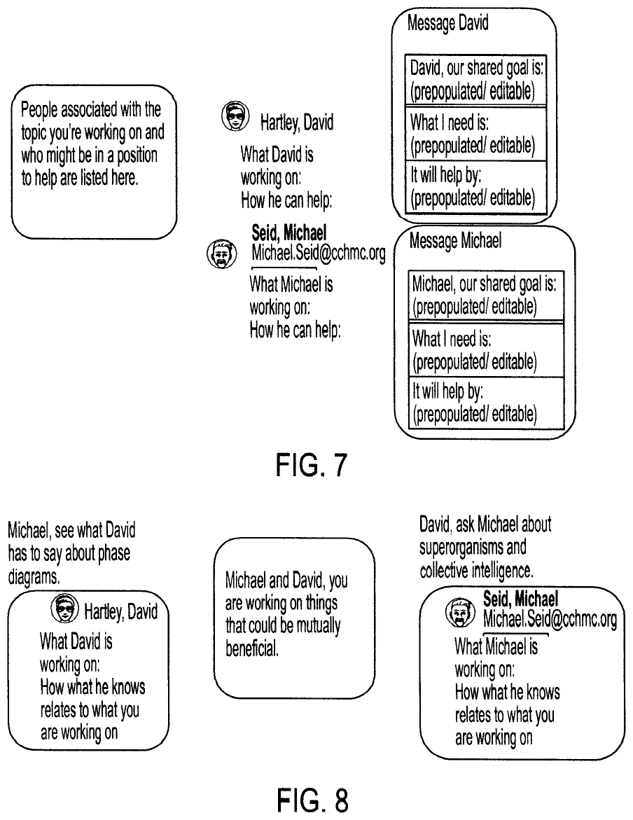

FIG. 7 provides a similar dashboard in which the system is proactively suggesting to a user, other actors in the network who may help the user with a topic that the user is working on, and also provides a pre-drafted (and/or editable) message that the user can select to open up communication/collaboration. The pre-drafted message may include background on why the potential collaboration would be beneficial to both actors. Again, these suggested collaborations may be with actors who the user may have never met, collaborated with before or even knew existed in the network (which may be a common issue in heavily secure or compartmentalized environments). As described herein, the match-maker functionality may include multi-language and/or dialect capabilities so that embodiments may have the ability to render the pre-drafted message(s) in a language(s), dialect(s), communication form(s) (e.g. accounting for disabilities of an actor such as using sign-language, brail, symbols and the like) that may benefit certain actor(s). Likewise, the match-maker functionalities may additionally take into account various data/information protections or protocols (e.g., encryption technologies) required for the pre-drafted messages and other communications with or between certain actors.

FIG. 8 provides a similar dashboard in which the system proactively recognizes that two actors are working on things and/or have knowledge that could be mutually beneficial to each other and then creates a microstructure to promote interaction between the two actors. For example, the system may explain what areas each actor is working on, their relevant backgrounds and areas in which the actors may benefit the other actors. Then the system can promote interaction/collaboration further by arranging meetings or preparing initial communications between the actors as described above.

Referring back to FIG. 2, Module 4.0 120 uses output from Module 3.0 118 to deploy and test multiple smaller-scale interventions at one or more levels (e.g., agent, agent-network, or structural; nested). This allows head-to-head testing and testing interventions on different samples or for different situations. Various different interventions are possible, including: (1) Interventions deployed by the platform. For example, resources identified as relevant to individuals or groups, and potential collaborators or experts can be ‘pushed’ or recommended via messaging or alerts. Likewise, structural holes can be closed by inviting agents to meet, explore common interests, and develop collaborative projects. (2) Interventions implemented by the community. For example, actors may agree on processes for work to be done and lanes of accountability, or they may decide to actively attract more agents to be engaged in the work. (3) Interventions may require building organizational architecture. For example, a common operating picture for a particular problem set may be needed, or policies regarding membership, governance, decision making may need to be generated. Evaluation may be carried out based on a priori criteria related to metrics of collaboration and AOA.

As described above, in an exemplary embodiment, interventions will be selected as a function of anticipated payoff and feasibility. Many functions are conceivable, e.g., identify subset of interventions with payoff and feasibility both exceeding a minimal cutoff and rank by payoff; identify subset of interventions with payoff and feasibility both exceeding a minimal cutoff and rank by feasibility; rank by mean of payoff and feasibility; etc. Different functions may be adopted based on, among others, time-to-optimal-result.

Interventions at the agent, agent-network, and structural level, will have some degree of effectiveness. To increase collaboration and improve actor-orientation, Module 5.0 122 seeks to improve these interventions and assess if more or different interventions are beneficial to improve the autonomous actor network's position relative to optimum performance. Module 5.0 122 uses updated data from Module 1.0 114, the contour plots from Module 2.0 116, and the output from Module 4.0 120 to improve algorithms and to course correct. After Module 4.0 120 implementation of agent or agent-network interventions, Module 5.0 122 re-runs Module 1.0 114 to assess collaboration and actor-orientation and uses these data and machine learning to develop and improve algorithms for pushing the most appropriate resources, connecting the most relevant actors, and identifying and predicting which actors are ‘at risk’ for increased engagement or collaboration. After Module 4.0 120 implementation of organizational interventions, Module 5.0 122 uses Module 1.0 114 data on actor-orientation to reassess the autonomous actor network's current state from Module 2.0 116 and determine the degree to which Module 4.0 120 interventions are likely to move the network closer to the optimum.

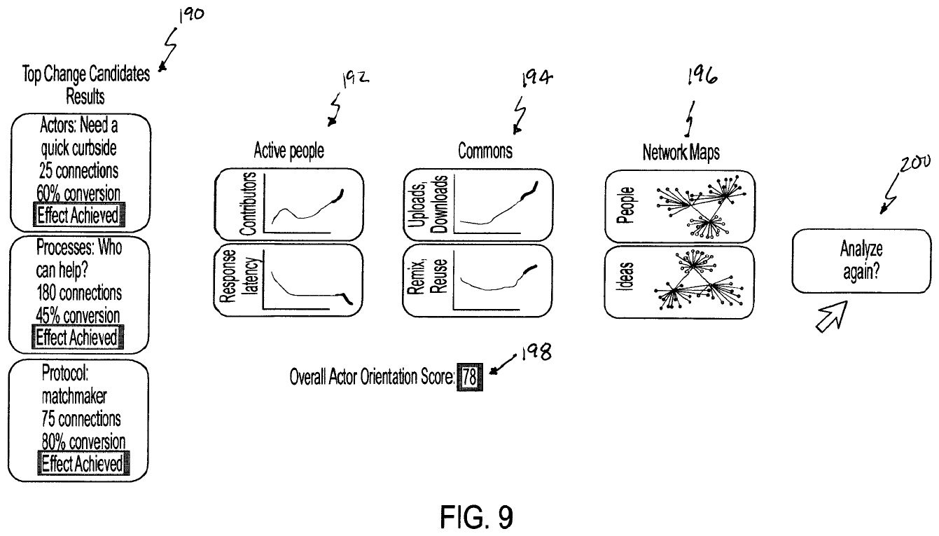

FIG. 9 provides an example of a graphical user interface dashboard for an operator or administrator, which can display the current state of the network at Module 5.0 122 showing the operator what happened in the latest run through the GRACE core loop. In this example, the top change candidates and results 190 are shown. For example, this example shows that 25 curbside connections between actors were suggested with a 60% conversion rate; 180 “who can help” connections between actors were suggested with a 45% conversion rate; and 75 matchmaker connections were suggested with an 80% conversion rate. Also, the improvements to active actors 192, commons 194, and network maps 196 are illustrated with a improved score 198 of 78. Finally, this dashboard allows the operator to run through the loop again with the “Analyze Again?” button 200.

Referring back to FIG. 2, Module 6.0 124 operates outside of the GRACE 106 core loop of Modules 1.0→2.0→3.0→4.0→5.0→1.0. Module 6.0 124 records and analyzes all information as the GRACE core loop iterates to learn what interventions work under different model states (storing that knowledge in a library, for example, as discussed above). Module 6.0 124 also provides intervention suggestions (e.g., from the library) based on what has worked in the past under related conditions when such conditions re-occur. In an embodiment, Module 6.0 employs a variety of AI methods, including but not limited to supervised machine classification (e.g., SVM) and large language models (LLMs). Module 6.0 124 also allows the ability to provide explainability, transparency and fairness to the GRACE core 106 process (e.g., ability to explain what a system is actually doing in the level that the user will understand, explain the constraints that are being implemented, and avoidance of bias in operation).

In an embodiment, Module 6.0 124 may operate to monitor and correct imbalanced resource allocation among autonomous actors (e.g., processing units such as CPUs, GPUs, TPUs, associated memories and the like) to monitor for livelock, deadlock and/or starvation conditions (or leading to such conditions) with such autonomous actor networks.

By following these processes, regardless of specific problem sets actors pursue on GRACE 106, the platform continually measures actor orientation and adapts in order to increase and optimize collaboration. GRACE 106 is resilient because it continues to carry out its mission in the face of adversity, e.g., when actors are not collaborating effectively. It may be built and housed in a cloud computing environment utilizing multiple availability zones, so that GRACE is resilient against engineering service threats. GRACE 106, or aspects of GRACE 106, may also be provided as an extension or add-on to existing (or new) computer implemented collaborative platforms and/or computer implemented social network platforms to optimize collaboration and/or achieving set goals using such platforms. For example, an embodiment of a computer implemented collaborative platform may include: a computer implemented collaborative platform configured so that autonomous actors using the platform (in which such autonomous actors may include humans as well as electronic entities including “bots” (automated programs that can perform repetitive tasks), “ai actors” (which can engage in more complex interactions, such as virtual assistants or recommendation systems) or other like artificial intelligence entities) may accomplish specific goals or solve business and/or technical problems through document management, idea sharing and task management; and a computer-implemented match-maker functionality configured to recognize collaboration gaps between two or more autonomous actors utilizing the computer implemented collaborative platform and to initiate and facilitate interactions between the two or more actors; where the computer-implemented match-maker functionality includes, (a) a knowledge network layer of elements including topics that actors in the autonomous actor network are concerned with, (b) a social-knowledge network layer that models how the actors in the autonomous actor network interact with elements in the knowledge network layer, and (c) social-network layer that maps which actors are connected in the autonomous actor network. In a further detailed embodiment, such match-maker functionality may configured to facilitate interactions between the two or more autonomous actors by generating invitations to collaborate among the two or more autonomous actors, wherein the invitations include purpose-value propositions for collaboration. In a further detailed embodiment, the invitations further include initial scripts for communication between the two or more actors. In a further detailed embodiment, the invitations facilitate scheduling a call or meeting between the two or more actors.

In an embodiment, initially, the goal is to generate (manually or automatically) labelled datasets of payoff, feasibility, and performance of interventions over time, so that machine learning (supervised learning, e.g., support vector machine classifiers) may be implemented when sufficient data are accumulated. Non-supervised approaches are also applicable.

Example GRACE use cases.

Use Case 1: A newly formed LHN to improve outcomes for Bipolar Disorder (BD) is beginning to collaborate across 18 health systems and with a dozen people with lived experience (PLE). Key focus areas for improvement include clinical care (standardized diagnostic process, quarterly assessment of health status, and guideline-concordant treatment) and implementing clinic-based peer support across all 18 care centers.

Since the LHN is new, relatively small, and inexperienced with Quality Improvement, it is important for the community to learn how to work together and make changes.

1. How it's done now: There are few interactions among clinicians and between clinicians and PLE, though there are many interactions among PLEs. Scott, a PLE, is on the Expert Faculty Committee with several clinicians. Network staff take the initiate with relatively passive clinicians and PLEs who have subject matter expertise, to develop clinical or peer-support resources. All materials are posted to the platform but are primarily accessed via monthly network calls or biannual network meetings. Process change is slow, and care centers mostly learn on their own.

2. What doesn't work: It's hard to find others to work with: Protocols for advertising skills are underdeveloped—while user profiles include a section for skills and interests, these consist of free-text fields and are often left blank. It's hard to overcome passivity: Clinicians and PLEs are used to Network staff reaching out to organize work groups.

3. The process applied: Simulations under current parameters suggest limited collaboration and slow improvement. Better protocols for advertising of skills, closing structural holes, and creating more connections among agents are all interventions that, in the simulation, substantially increase engagement, the amount of knowledge shared, and improved care processes. Structural gaps between clinicians and PLEs are closed, using Scott's position as a boundary-spanner to broker these connections. Connections are created among users with similar interests, based on platform use (what is searched for, viewed, downloaded) and updated user profiles. Clinicians and PLEs are prompted to reach out and help others to solve problems.

4. What this achieves: More connections are made among clinicians and PLEs who likely have complementary expertise. More resources (knowledge, expertise) are shared. More users are increasingly engaged-contributing to resources development. With established protocols for facilitating multi-actor collaboration, the LHN can turn to attracting more clinicians and PLEs to be part of the work.

Use Case 2: An existing LHN of patients and clinicians at more than 110 clinical care sites is focused on improving remission rates for patients with pediatric inflammatory bowel disease. They have a robust patient advisory council (PAC) that has developed multiple patient resources and an ongoing blog, several contracts with Federal, private, and industry funders for research, and well-developed population management and pre-visit planning tools. Care centers are organized into groups according to improvement level. The remission rate for the network has increased from 60% to 82% over the last 15 years, but the rate of improvement has decreased.

1. How it's done now: A relatively small group of highly engaged clinicians and patients interact extensively. The PAC has a variety of channels (SnapChat, What'sApp) with even denser connections. The PAC regularly posts new patient-focused resources on the public-facing website. The public-facing website has steady traffic, including pages where resources can be viewed and downloaded. Sign-ups for the blog and other communications for the network increase slowly, but steadily. Process improvement at clinical sites is robust. LHN leaders and the PAC hypothesize that the LHN could increase the remission rate to 87% with better self-management.

2. What doesn't work: Despite a core group of highly engaged people, the vast majority of patients and families in the LHN are unaware of the wide variety of resources available and only occasionally browse these. Making patients and families aware of the LHN is difficult, given HIPAA, and previous attempts to have clinicians encourage their patients to be more involved have been minimally successful and short-lived.

3. The process applied: Simulations suggest that if a) 80% of clinicians can influence ⅓ of their patients to visit the website, b) there were sufficient resources available for self-management, and c) the top decile of non-adherent patients improved their medication self-management by 50%, there would be an inflection point in the number of people involved and a substantial increase in self-management and improved outcomes. The LHN organizes a network-wide quality improvement effort to increase the reliability by which clinicians use a QR code to ‘prescribe’ a website visit. The PAC undertakes a recruitment drive and organizes themselves to develop self-management tools for diverse patients and families. They also expand the local PAC chapters to increase social support. The LHN registry is analyzed to identify patients at highest risk for non-adherence and algorithms are built and updated to better pinpoint who might benefit from more intensive clinical referral.

4. What this achieves: A coordinated and calibrated multifactorial effort, using the strengths of the LHN, to most efficiently improve outcomes.

“Organizational architecture” is hard to see, but its effects are profound. The ways that resources are allocated, decisions are made, and tasks are assigned has a major impact on the ability of groups of people to achieve their goals. A healthcare system characterized by centralized decision making, rigid roles, and layered reporting structures is one that will be inflexible, slow to adapt, and incapable of making the best use of its human and other resources. Indeed, this is omnipresent at present. Alternate organizational forms are possible, as illustrated by LHNs, but these are few and small, relative to the need. GRACE solves this problem by enabling rapid scaling and systematic improvement of the collaborative sociotechnical platform underlying LHNs. By rapidly adapting to internal and external conditions to enhance and maintain the ability of systems and people to deliver care and improve health outcomes, GRACE enables revolutionary advances in the science, technology, and methods of collaborative learning health systems.

As such, a variety of users will benefit from utilizing GRACE, including: (A) LHNs: Existing, nascent, and future LHNs who recognize the foundational role of collaboration in improving outcomes. The Bipolar Action Network and ImproveCareNow have expressed interest. (B) Enterprise collaborative platform vendors who could integrate this into their platforms. Such a utility could be embedded in Microsoft Teams. Hive, a company that supports LHNs, is interested. (C) Hospitals and related healthcare organizations who need to increase the speed of delivering better patient outcomes. Cincinnati Children's Hospital is interested in using this. (D) Healthcare payers who want to improve, using LHNs, conditions that can be managed outside the hospital in order to increase capacity to treat complex conditions in the healthcare system. (E) Public health and hospital systems that need to collaborate in the face of crises, as was seen in both COVID-19 and the recent IV fluid shortage events. (F) Federal, state, local responders to, e.g., bioterrorism and related events that are expected to affect both healthcare systems and local, regional, and state health departments and organizations. (G) Research funders who need to improve multistakeholder collaboration across traditional community, hospital, and academic boundaries. NIH/NCATS' Clinical Translational Science Awardees and Rare Disease Clinical Research Network.

EVALUATION. Evaluating the effectiveness of collaboration improvement: As described earlier, GRACE core Module 1.0 114 will generate a COP of collaboration metrics. By monitoring COP metrics, users will see objective measures of improved collaboration, and rate of improvement, as their projects progress. In this way, individual projects can evaluate their collaborative trajectory and be able to assess how utilizing GRACE supports their overall collaborative objectives.

As discussed above the current disclosure applies broadly to all AOAs including, for example, (and without limitation) the processing of a nuclear reactor, a distributed computer system, a pizza baking shop, and a learning health system and so forth. As also disclosed herein, embodiments of the disclosure may be incorporated into or with a computer implemented collaboration platform and/or with various computer-implemented social media platforms.

### Computing Environment

The computing engines (e.g., the GRACE core 106), modules, machine learning modules, machine learning engines, deep learning modules/engines, training systems, architectures and other disclosed functions may be embodied as computer instructions that may be installed for running on one or more computer devices and/or computer servers. In some instances, a local user can connect directly to the system; in other instances, a remote user can connect to the system via a network.

Example networks can include one or more types of communication networks. For example, communication networks can include (without limitation), the Internet, a local area network (LAN), a wide area network (WAN), various types of telephone networks, and other suitable mobile or cellular network technologies, or any combination thereof. Communication within the network can be realized through any suitable connection (including wired or wireless) and communication technology or standard (wireless fidelity (WiFi®), 4G, 5G, long-term evolution (LTE™)), and the like as the standards develop.

The computer device(s) and/or computer server(s) can be configured with one or more computer processors and a computer memory (including transitory computer memory and/or non-transitory computer memory), configured to perform various data processing operations. The computer device(s) and/or computer server(s) also include a network communication interface to connect to the network(s) and other suitable electronic components.

Example local and/or remote user devices can include a personal computer, portable computer, smartphone, tablet, notepad, dedicated server computer devices, any type of communication device, and/or other suitable compute devices.

The computer device(s) and/or computer server(s) can include one or more computer processors and computer memories (including transitory computer memory and/or non-transitory computer memory), which are configured to perform various data processing and communication operations associated with diagnosing psychiatric disorders as disclosed herein based upon information obtained/provided (such as the LHN data discussed above) over the network, from a user and/or from a storage device. In some implementations, storage device can be physically integrated to the computer device(s) and/or computer server(s); in other implementations, storage device can be a repository such as a Network-Attached Storage (NAS) device, an array of hard-disks, a storage server or other suitable repository separate from the computer device(s) and/or computer server(s).

In some instances, storage device(s) (which may comprise non-transitory memory) can include the machine-learning models/engines and other software engines or modules as described herein. Storage device(s) (which may comprise non-transitory memory) can also include sets of computer executable instructions to perform some or all the operations described herein.

The computer implemented nature of the current disclosure allows performance of Modules 1.0 114, Module 2.0 116, Module 3.0 118, Module 4.0 120, Module 5.0 122, and/or Module 6.0 124 (or any combination thereof) in real-time, near real-time and/or at a scale that cannot be practically possible with a human mind (or multiple human minds). Additionally, language, dialect, and jargon issues that the matchmaker function aims to overcome are also not surmountable in terms of human-based mental processes, because generally a human mind does not know what it does not know. For example, while a human can look up synonyms and translations, in general a user lacking expertise and competence in a language or specific domain cannot necessarily utilize a tool such as a search engine or a dictionary and be an effective matchmaker. To illustrate, consider looking up specific the words in the following phrase in Chinese, [symbol] . That would lead to the direct translation of “above 7 below 8”, which is meaningless absent cultural knowledge. It actually means “be agitated or perturbed”. Someone saying “ [symbol] ” (“I'm confused!”) might be paired with an English speaker who's abnormally tall, instead of someone who can alleviate confusion. Additionally, the black-box functionality described herein cannot be practically performed in the human mind at any scale, because the individual would need to have access to protected data and human memory is not erasable.

It is understood that the aforementioned Modules 1.0 114, Module 2.0 116, Module 3.0 118, Module 4.0 120, Module 5.0 122, and/or Module 6.0 124 as well as any additional technologies and/or functionalities (e.g., the match-maker functionality) discussed herein are intended for purposes of enabling the present embodiments, rather than limiting the scope of the disclosure. As such, a person of ordinary skill will understand that the present disclosure covers apparent alternatives, modifications, and equivalents (e.g., combining any of the separate Module 1.0 114, Module 2.0 116, Module 3.0 118, Module 4.0 120, Module 5.0 122, and/or Module 6.0 124 and/or disclosed functionalities in any operational way) made to the techniques described herein. It will also be understood that the disclosed operations of Modules 1.0 114, Module 2.0 116, Module 3.0 118, Module 4.0 120, Module 5.0 122, and/or Module 6.0 124 and/or any disclosed additional functionalities correspond to various algorithms for operating such Modules and/or functionalities.

While particular embodiments of the present invention have been illustrated and described, it would be apparent to those skilled in the art that various other changes and modifications may be made without departing from the spirit and scope of the invention. It is, therefore, intended to cover in the appended claims all such changes and modifications that are within the scope of this invention.

To the extent any references incorporated herein by reference are inconsistent with or conflict with any disclosure, terms, or meanings of terms or use of terms provided herein, then this disclosure controls.

1. A system for evaluating and enhancing an autonomous actor network comprising:
a first computer-implemented current state assessment module, assessing a current representation of an autonomous actor network and providing a first output;
a second computer-implemented simulation module, using the first output and simulating potential individual and ensemble interventions in the current autonomous actor network and providing a second output indicating effects of the simulations;
a third computer-implemented ranking and selection module, using the second output and assembling a third output in the form of a set of the potential interventions ranked by feasibility and potential impact to increase collaboration in the autonomous actor network;
a fourth computer-implemented intervention evaluation module, using the third output to test multiple of the potential interventions at one or more levels providing a fourth output; and
a fifth computer-implemented update and correction module, using the second output and the fourth output to at least one of update or correct the current autonomous actor network representation.

2. The system of claim 1, wherein the first output includes an indicator matrix and a dashboard depicting individual metrics within each category of actor information and a summary of system metrics.

3. The system of claim 1, wherein the first computer-implemented module ingests a corpus of text or other data concerning the current autonomous actor network and searches for actor-oriented indicators.

4. The system of claim 1, wherein the first computer-implemented module logs data of actor behavior in the current autonomous actor network to derive autonomous actor network structure and metrics.

5. The system of claim 1, wherein the second output includes a contour plot denoting the intervention terrain for the autonomous actor network to navigate to increase collaboration.

6. The system of claim 1, wherein the second computer implemented module includes an agent-based model computer program in which populations of actors with various attributes interact according to rules predetermined for environments, and models future states of collaboration and actor orientation associated with the current autonomous actor network with a range of values across parameters, wherein certain influential parameters are varied systematically over a range of values.

7. The system of claim 1, wherein the third computer implemented model:
generates interventions as multiple levels, including agent level, agent-network level, structural level and/or nested level;
identifies a set of types of interventions likely to improve actor-oriented collaboration;
generates interventions from the cover set that are tailored to the nature of the developmental stage of the current autonomous actor network; and
ranks the interventions by impact and feasibility.

8. The system of claim 7, wherein feasibility is addressed by:
a degree to which the intervention can be implemented by the platform alone;
a degree to which there is existing infrastructures, processes, and/or protocols; and
a relative strength of the organization across dimensions of actor-orientation.

9. The system of claim 7, wherein impact is determined by relative movement in collaboration due to the intervention.

10. The system of claim 1, wherein the fifth computer implemented model uses a machine learning model to develop and improve algorithms for pushing appropriate resources, connecting the most relevant users, and identifying and predicting which users are likely for increased engagement or collaboration.

11. The system of claim 1, further comprising a sixth computer-implemented assessment and learning module that analyzes the performance of first, second, third, fourth and fifth computer implemented modules to learn from, store and have the ability to re-introduce successful interventions from the set of potential interventions.

12. The system of claim 11, wherein the sixth computer-implemented assessment and learning module resides outside of a recursive loop comprising the first, second, third, fourth and fifth computer implemented modules.

13. The system of claim 11, wherein the sixth computer-implemented assessment and learning module employs a plurality of resources including supervised machine classification and large language models to learn from the set of potential interventions and to provide one or more of transparency, explainability and fairness to the system.

14. The system of claim 1, further comprising a sixth computer-implemented assessment and learning module that analyzes a recursive loop comprising the first, second, third, fourth and fifth computer implemented modules to monitor for and correct imbalanced resource allocation among actors in the autonomous actor network.

15. The system of claim 1, further comprising a sixth computer-implemented assessment and learning module that analyzes a recursive loop comprising the first, second, third, fourth and fifth computer implemented modules to monitor for and correct at least one of livelock, deadlock or starvation conditions in the autonomous actor network.

16. The system of claim 1, wherein the system further comprises a computer-implemented match-maker functionality configured to recognize collaboration gaps between two or more actors in the autonomous actor network and to set initiate and facilitate interactions between the two or more actors.

17. The system of claim 16, wherein the match-maker functionality is configured to facilitate interactions between the two or more actors by generating invitations to collaborate among the two or more actors, wherein the invitations include purpose-value propositions for collaboration.

18. The system of claim 17, wherein the invitations further include initial scripts for communication between the two or more actors.

19. The system of claim 17, wherein the invitations facilitate scheduling a call or meeting between the two or more actors.

20. The system of claim 16, wherein the match-maker functionality generates and utilizes:
a knowledge network layer of elements including topics that actors in the autonomous actor network are concerned with;
a social-knowledge network layer that models how the actors in the autonomous actor network interact with elements in the knowledge network layer; and
social-network layer that maps which actors are connected in the autonomous actor network.

21. The system of claim 20, wherein the match-maker functionality is configured to:
identify clusters of related topics in the knowledge network layer that differ by one or more of linguistic expression, language, dialect, education level, or knowledge level;
determine if distinct, non-overlapping sets of actors correspond to the clusters of related topics; and
initiates and facilitates interactions between the non-overlapping sets of actors that correspond to the clusters of related topics.

22. The system of claim 21, wherein the match-maker functionality is configured to generate invitations for collaboration between the non-overlapping sets of actors that correspond to the clusters of related topics, wherein the invitations account for different linguistic expression, language, dialect, education level, or knowledge level between the non-overlapping sets of actors that correspond to the clusters of related topics.

23. The system of claim 20, wherein the social network layer analyzes search queries of actors in the autonomous actor network against elements in the knowledge network layer.

24. The system of claim 23, wherein the social network layer is further configured to determine whether actors' search queries are ineffective with respect to elements in the knowledge network layer due to linguistic expression, language, dialect, education level, or knowledge level; and the match-maker functionality is configured to generate invitations for collaboration between actors using ineffective search queries and other actors identified as having knowledge related to topics queried in the ineffective search queries.

25.-62. (canceled)

63. The system of claim 1, wherein the autonomous actor network comprises a multitude of autonomous actors taken from a group consisting of: distributed software-based applications, virtual actor frameworks, or distributed artificial intelligence workloads.
